(19) United States
(12) Patent Application Publication
(10) Pub. No.: US 2013/0235154 A1
(43) Pub. Date: Sep. 12, 2013

(54) METHOD AND APPARATUS TO MINIMIZE COMPUTATIONS IN REAL TIME PHOTO REALISTIC RENDERING

(71) Applicants: Guy Salton-Morgenstern, Rockville, MD (US); Roy Baharav, Newbury Park, MD (US)

(72) Inventors: Guy Salton-Morgenstern, Rockville, MD (US); Roy Baharav, Newbury Park, MD (US)

(21) Appl. No.: 13/792,282

(22) Filed: Mar. 11, 2013

Related U.S. Application Data
(60) Provisional application No. 61/608,700, filed on Mar. 9, 2012.

(51) Int. Cl. H04N 13/00

(52) U.S. Cl. CPC H04N 13/0029
USPC 348/43

(57) ABSTRACT

Method and apparatus to minimize computation in real time photo realistic rendering for efficiently creating, in real time, personalized videos that include personal images and personal text and targeted advertising arts according to viewer profiles. The method and apparatus for automatically and photo realistically embedding artwork onto video content generally includes a container implanter that creates generic 2D containers for an image artwork, which includes instructions for embedding the artwork, automatically and photo realistically, onto video content, and a renderer or network renderer that automatically and photo realistically embeds the artwork onto video content.

### RELATED APPLICATION

This application claims priority under 35 U.S.C. §119(e) to U.S. Provisional Application No. 61/608,700, filed Mar. 9, 2012, which is hereby incorporated by reference in its entirety.

### BACKGROUND

The field of the present invention relates generally to digital product placement and more specifically it relates to a method and apparatus to minimize computations in real time photo realistic rendering for efficiently creating in real time personalized videos that include personal images, personal text, and targeted advertising artwork based on viewer profiles.

### SUMMARY

Embodiments of the present invention provide a method and apparatus for automatically, efficiently and photo realistically embedding artwork onto video content for creating, in real time, personalized videos that include, personal images, personal text and targeted digital product placement advertising according to viewer profile. Embodiments of the present invention also provide a method and an apparatus for preparing content for future automatic efficient and photo realistic insertion of any artwork that meets a pre-defined specification.

The invention may be embodied as a method of providing for real time photo realistic rendering of artwork onto video content. The method includes: activating a computer to define segments in the video content; activating the computer to define 3D containers for the segments; activating the computer to convert the 3D containers into corresponding 2D containers; and sending the 2D containers through a network. The video content, the artwork, and the 2D containers become available to a viewer activating an electronic device to receive through the network the video content and the artwork and to play the video content with the artwork photo realistically rendered thereon according to instructions in the 2D containers.

The invention may also be embodied as a container implanter residing on a computer. The container implanter includes: a 3D to 2D converter residing on the computer and operative to convert 3D containers for segments defined in video content into 2D containers; and network access circuitry enabling the receipt of the video content through a network and the transmission of the 2D containers through the network. When activated, the 3D to 2D converter converts the 3D containers for the segments defined in the video content into 2D containers and the 2D containers are sent through the network using the network access circuitry so that the video content, the artwork, and the 2D containers become available to a viewer activating an electronic device to play the video content with the artwork photo realistically rendered thereon according to instructions in the 2D containers.

The invention may further embodied as a machine readable storage medium containing instructions that when executed cause a container implanter to provide for real time photo realistic rendering of artwork onto video content by: defining segments in the video content; defining 3D containers for the segments; converting the 3D containers into corresponding 2D containers; and sending the 2D containers through a network. The video content, the artwork, and the 2D containers become available to a viewer activating an electronic device to receive through the network the video content and the artwork and to play the video content with the artwork photo realistically rendered thereon according to instructions in the 2D containers.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 presents a block diagram illustrating an example of the invention embodied as an apparatus to minimize computations in real time photo realistic rendering;

FIG. 2 presents a flowchart representing an exemplary process of creating a 2D container out of a 3D container as performed by an embodiment of the invention;

FIGS. 3A and 3B illustrate the results of an embodiment of the invention;

FIG. 4 is a block diagram illustrating components of a 2D container of an embodiment of the invention;

FIG. 5 is a block diagram illustrating components of a 3D container of an embodiment of the invention;

FIG. 6 presents a flow chart representing an exemplary process of rendering as performed by embodiments of the invention.

FIG. 7 presents a block diagram illustrating an alternate embodiment of the invention in which the renderer is accessible via a network;

FIG. 8 presents a flow chart representing an exemplary process of preparing video content for future embedding of artwork as performed by embodiments of the invention; and

FIGS. 9A and 9B illustrate how a wrapping layer of an embodiment of the invention is represented.

### DETAILED DESCRIPTION

The invention summarized above and defined by the claims below will be better understood by referring to the present detailed description of embodiments of the invention. This description is not intended to limit the scope of claims but instead to provide examples of the invention. This detailed description describes embodiments in which a container implanter (162) creates generic two-dimensional (2D) containers (344) for image artwork that include instructions for embedding the artwork automatically and photo realistically onto video content and a renderer (164) or network renderer (64) that automatically and photo realistically embeds the artwork onto video content.

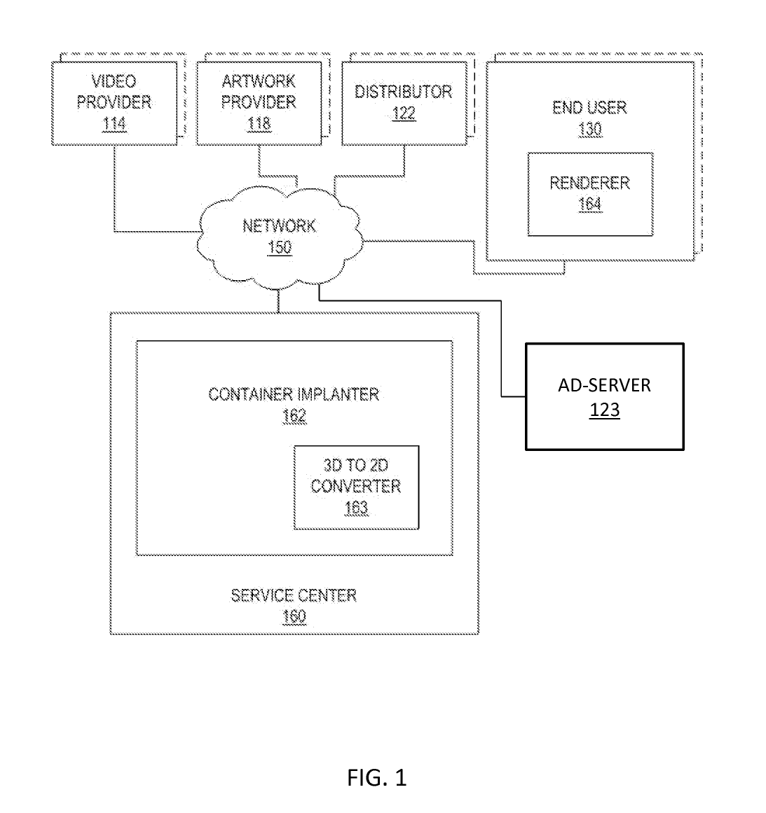

Reference is now made to the block diagram of FIG. 1, which illustrates an embodiment of the invention within its environment. This embodiment, an apparatus to minimize computations in real time photo realistic rendering, is a container implanter 162, which functions with the other elements of the system environment as follows: A video provider 114 provides video content. A service center 160, using the container implanter 162 equipped with a three-dimensional (3D) to two-dimensional (2D) converter 163, generates graphic instructions for automatic photo realistic embedding of artwork onto the video provided by the video provider 114. An artwork provider 118 provides the image to be embedded. A distributer 122 distributes the video content to an end user 130 having a renderer 164 hosted on an electronic device (such as a computer, smart phone, or tablet, as non-limiting examples) that photo realistically embeds the artwork onto the video content using the graphic instructions. A network 150, such as the Internet or a local area network (LAN), enables the various elements to communicate with each other.

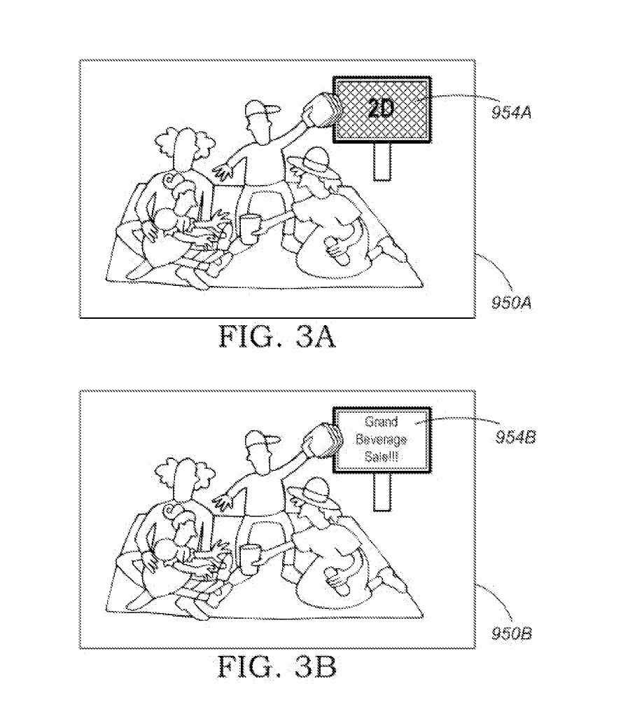

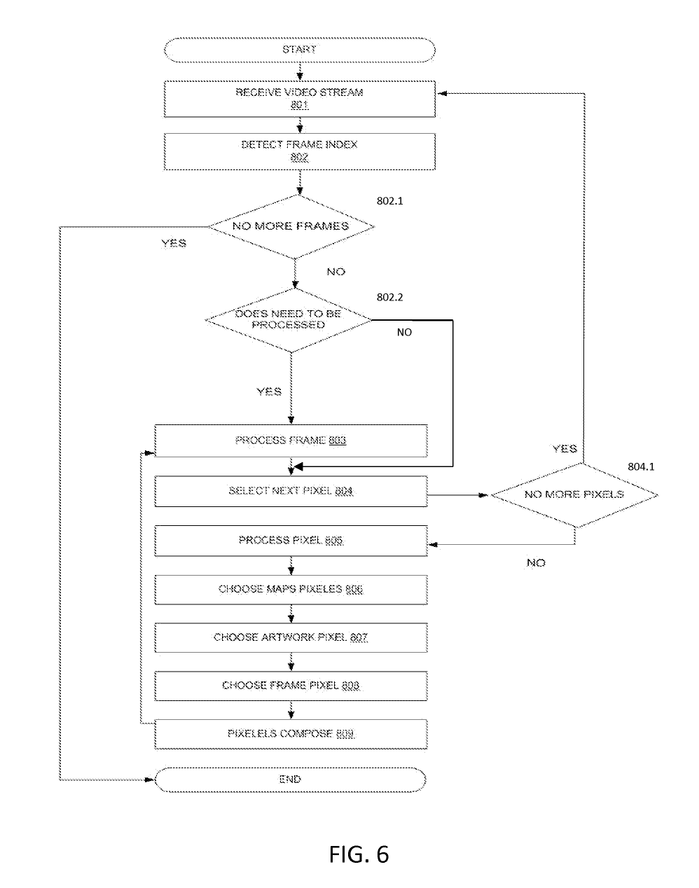

The container implanter 162 of the present embodiment is implemented as software running on a computer, which aids an operator in defining times and places within video content where external image artwork can automatically and photo realistically be embedded onto the video. (See FIGS. 3A and 3B, which describe the outcome of the rendering process described with reference to FIG. 6 below. In FIG. 3A, a billboard sign is defined, and it can contain artwork. In FIG. 3B, specific artwork is composed on top of the billboard based on a 2D container 344.). The container implanter 162 includes a 3D to 2D converter 163 that optimizes the 3D container 355 embedding instructions by converting them to 2D container 344 embedding instructions that enable a renderer 164 or network renderer 64 to automatically and photo realistically embed image artwork in real time onto video content.

The computer hosting the container implanter 162 may be a personal computer, a Macintosh, a workstation, or a server, as non-limiting examples. Generally, the computer has a processor and storage (or access to storage) that holds instructions. The instructions, when executed, cause the processor to activate the container implanter 162 to perform the functions disclosed herein. The computer interacts with (or provides) network access circuitry of (or to) the container implanter 162 to enable the receipt of the video content through the network 150 and the transmission of the 2D containers through the network.

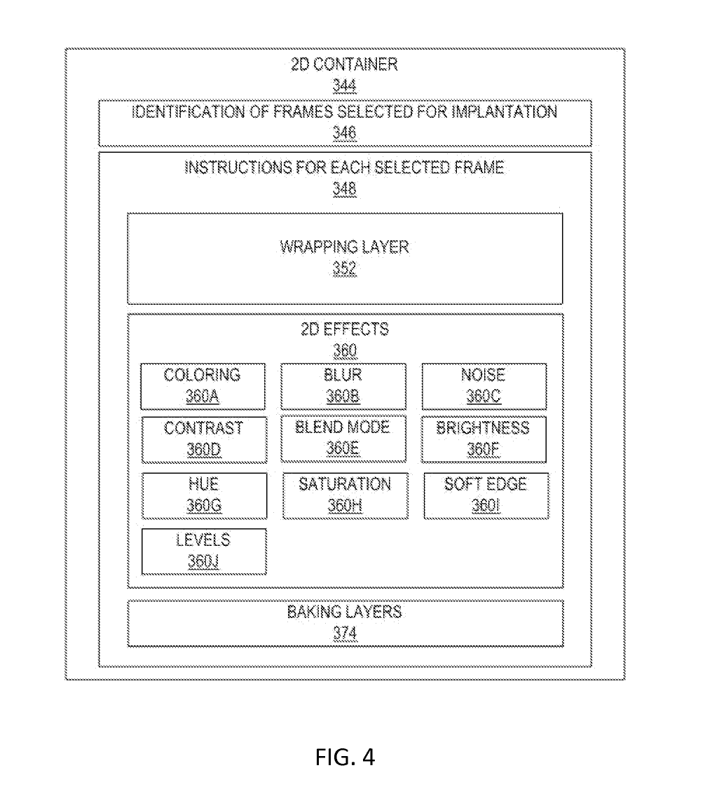

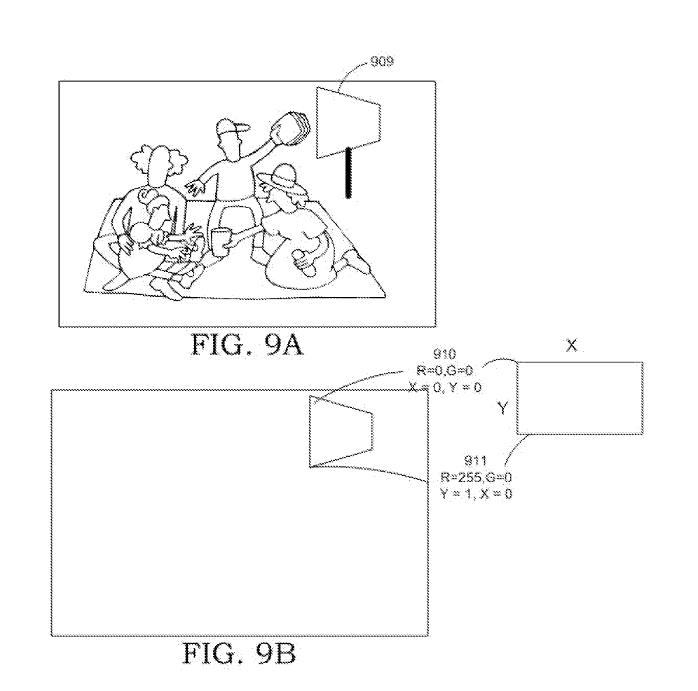

FIG. 4 illustrates components of the 2D container 344. The 2D container 344 includes (1) the identification of the frames selected for the implantation 346 in which the integration needs to take place and (2) instructions for each selected frame 348. For each frame, a set of artwork operators is defined within a wrapping layer 352, which is a mapping of the artwork pixels to the background pixels locations in each frame, as illustrated in FIG. 9B. A set of 2D effects 360 includes: coloring 360A that strengthens or weakens one or more RGB color attributes, blur 360B based on, for example, Gaussian blur or Poisson blur techniques, noise 360C based on normal pixel noise, contrast 360D, blend mode 360E such as normal or multiply blend, brightness 360F, hue 360G, saturation 360H, soft edge 3601 that creates a blur effect only at the edges of the artwork, and levels 360J. In addition, the 2D container 344 includes baking layers 374, which are the 2D representation of 3D effects such as and not just—specular, lights color, reflection, refraction, opacity, and dirt.

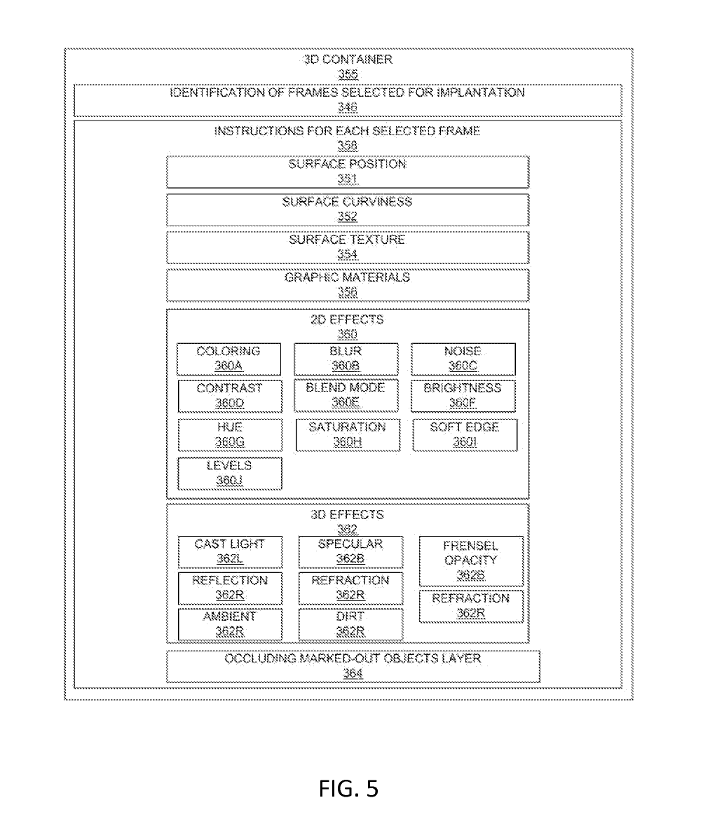

FIG. 5 is a block diagram illustrating sub-components of the 3D container 355. Within the 3D container 355 are a set of non-optimized operators enabling automatic and photo realistic embedding of an image artwork onto video content. These set of operators sometime require significant processing power in order to efficiently and photo realistically embed artwork onto video content.

The container implanter 162 of this embodiment is implemented as a post production software tool running on a computer that helps in defining reusable times and places where artwork can be photo realistically embedded onto video content. In order to define a 2D container 344, the tool provides the user with the ability to tag frames and to form the 2D container 344. Some functionality of the container implanter 162 can be achieved using off the shelf post production tools, such as Adobe After Effects, Apple Shake or Autodesk 3D Studio Max or through the system described in U.S. Pat. No. 7,689,062, “System and method for virtual content placement,” hereby incorporated by reference in its entirety. The container implanter 162 defines a 3D container 355 using camera tracking techniques, masking techniques to separate foreground from background, and a set of special effects that act as operators on objects inserted into the 3D container 355. Then, the 3D container 355 may be regarded as a 3D scene with a background video and a masking layer that, when rendered together with a specific artwork, generates photo realistic embedding of image artwork onto the video content. In order to efficiently and photo realistically embed artwork onto video in real time and with devices that have limited processing power, such as some smart phones or tablets, the 3D container 355 transforms to an equivalent set of instructions, the 2D container 344, using the 3D to 2D converter 163.

The processes of the 3D to 2D converter 163 are described with reference to FIGS. 9A and 9B, which illustrate how the wrapping layer 352 is represented. FIG. 9A shows a billboard sign positioned in 3D onto a frame from the original video content. FIG. 9B illustrate how a pixel 910 in the mapping layer corresponds to a pixel (910, also) from the artwork. The pixel 910 shows that at specific location in the wrapping layer 352 there is a pixel with color values as follows R=0 and G=0, which relates to location 0,0 at the artwork image. In addition, there is another example, a pixel 911, at a different location, where R=255, G=0, corresponding to location 0,1 in the artwork image. The location X,Y in the target artwork image is calculated according to the following:

$$PixelColor ( x , y ) = {ArtworkColor}_{z , w} ( \frac{\begin{matrix}WidthPixels * \\ {WRAPPING ( x , y )}_{RED}\end{matrix}}{255} , \frac{\begin{matrix}HEIGHT * \\ {WRAPPING ( x , y )}_{GREEN}\end{matrix}}{255} )$$

The 3D to 2D converter 163 executes two processes. The first process is transforming the 3D representation, based on camera position and 3D object description, to special 2D wrapping layer 352 (FIG. 4), such as is illustrated in FIG. 9B. The 2D wrapping layer 352, when is combined with the artwork, keeps the perspective aspects of the original 3D container 355 shape and location in the frame. One non-limiting exemplary way to represent the wrapping layer 352 is to place the target pixel location 910 in the RGB data of the wrapping layer 352. For example, the R byte can represent the Y axis index, where 0 represents 0 and 255 represents 1, and the G byte can represent the X axis index, where 0 represents 0 and 1 represents 255. An illustration of that mapping is presented in FIG. 9. The second process that the 2D to 3D converter 163 performs is called baking, and it includes the rendering of all the 3D scene effects into compositing baking layers 364 to later be composed easily with the artwork that wraps a shape in the scene. Without loss of generality, when integrating an artwork in 3D, one must handle different effects such as reflection, specular, diffuse color, ambient, transparency, and more. The pixel color equation can be described as follows:

$${P}_{Color} ( x , y ) = {{\sum }^{\# Effects}}_{i} {a}_{i} {F}_{i} ( x , y )$$

The 2D to 3D converter 163 generates backing layers 364, one for each effect. Each layer can be represented as:

aₓ*F_{N}(x,y)

The renderer 164 will be described in more detail with reference to FIGS. 1 and 4. The renderer 164 is a software tool running on a computer, such as an IBM- or Macintosh-compatible personal computer or workstation, or on a mobile device such, as smart phone or tablet, which automatically and photo realistically embeds artwork in real time onto streaming video content. The renderer 164 receives as an input a video stream artwork to be embedded and the 2D container 344. Using the 2D container 344 instructions, the renderer 164 composes, in each frame, pixels from the original video content, the artwork, and the baking layers 364 into a new video stream.

The renderer 164 may work according to the flow defined in FIG. 6 (discussed below). The renderer 164 downloads the 2D container 344 and starts to play or process the video stream. The renderer 164 monitors the video progress and detects in real time the current frame index using a detect frame index module. The detection can be done using different methods, such as counting frames from the beginning of the video or the beginning of a GOP (group of pictures in encoding scheme), or detecting pre-integrated, unique, per frame visual markers. If the detected frame needs to be processed according to the 2D containers 344, then a compositing process begins using the 2D container 344, the baking layers 364, the artwork, and the wrapping layers 352 to generate a new modified frame and then to return it to the stream.

Main elements and sub-elements of the embodiment are connected as shown in FIG. 1. The container implanter 162 includes within it the 3D to 2D converter 163. The container implanter 162 is connected to the renderer 164 or to the network renderer 64 through a network connection, such as the Internet or a LAN. The container implanter 162 uploads the 2D containers 344 to network storage (not shown for clarity) that can be accessed by the renderer 164 or the network renderer 64 when needed based on an end user 130 request to see a modified video.

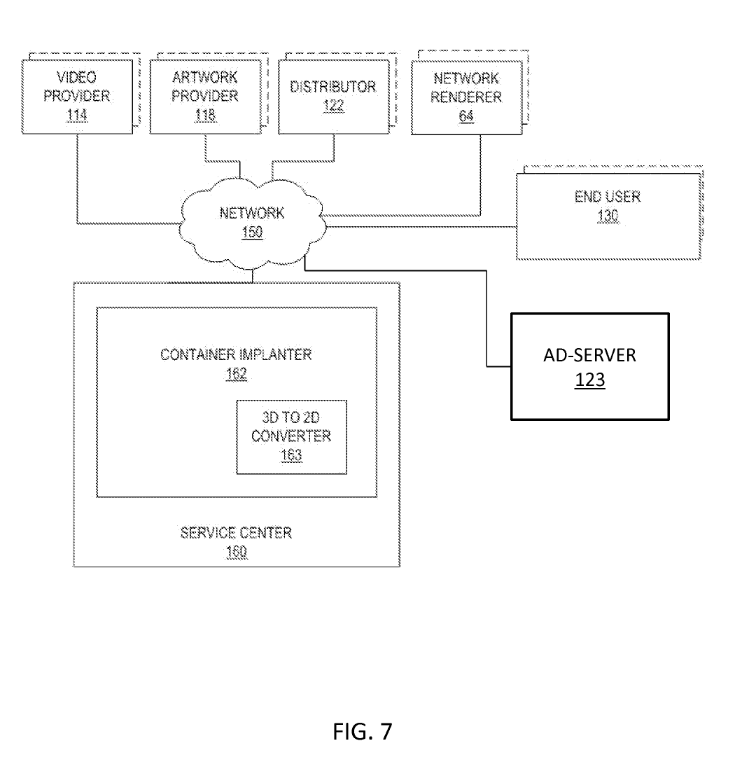

An alternate embodiment of the invention is discussed with reference to FIG. 7. Here, the renderer 164 resides, not at the end user 130 side, but at a server side, creating a network renderer 64. (The server hosting the network renderer 64 may host other system elements or may be dedicated exclusively to the network renderer 64.) When an end user wants to watch a video, the end user 130 video player (hosted on an electronic device, such as a computer, smart phone, or tablet, as non-limiting examples) calls the network renderer 64, which changes the video while streaming it to the end user 130. The network renderer 64 performs the same or an analogous compositing process as that performed by the renderer 164 in FIG. 1.

As illustrated in FIG. 7, the video provider 114 is the source of the video content, the service center 160, using a container implanter 162 having a 3D to 2D converter 163, generates the graphic instructions for automatic photo realistic embedding of artwork onto video content. The artwork provider 114 provides the image to be embedded, and the distributor 122 distributes the content to the end user 130 through the network renderer 64. The network renderer 64 does the actual photo realistic embedding of the artwork onto the video content using the graphic instructions represented by the 2D container 344, and sends the result to the end user 130 via the network 150 connection. The end user 130 then receives the result. The end user 130 end device can select the modified version of the video content or the original video content according to different types of marketing plans (or “business logic”). A non-limiting exemplary business logic is targeted advertising business logic.

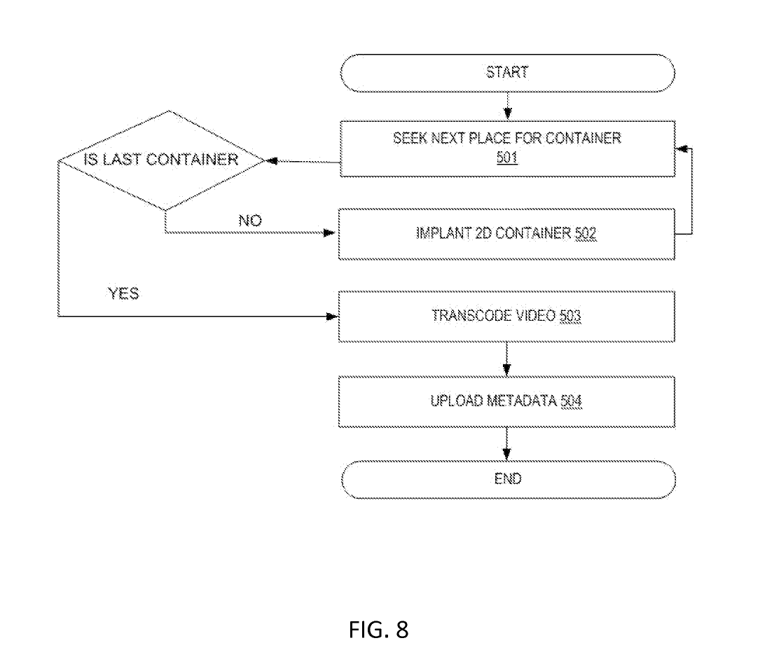

Embodiments of the invention may be used by a service provider to define and provide personalized videos created by photo realistically embedding artwork onto video content in real time. The process starts when the service provider receives video content that needs to be prepared for personalization and customization. The service provider then uses the container implanter 162 tool to define which segments in the video are to be personalized. The service provider then works on each of these segments by defining 3D containers 355, one for each segment. Each 3D container 355 describes specifically how an image should be integrated onto the original video content in a photo realistic way. The last step at this stage is the conversion of the 3D container 355 into an optimized representation that requires less processing power in order to photo realistically embed an artwork onto a video content, hence enabling a real time photo realistic embedding in mobile devices and tablets. The component that performs the conversion is called 3D to 2D converter 163. The output of the 3D to 2D converter 163 is a 2D container 344. Once the 2D container 344 is ready, it is uploaded to a server site, for example, to the distributer 122 or to an ad-server 123, as described below with respect to FIG. 8. In addition, the original video content is processed and uploaded to a server site owned by the distributer 122. The viewer then navigates to a website or calls for the video content in a different way and watches the video. While the video plays, the renderer 164 or the network renderer 64 fetches the video, artwork from the artwork provider 118, and the 2D container 344. It then modifies the playing video according to the instructions in the 2D container 344 and the artwork delivered by the artwork provider 118 based on the process described in FIG. 6. Finally, the viewer sees a modified version of the original video, which was produced in real time, like the one shown in FIG. 3B.

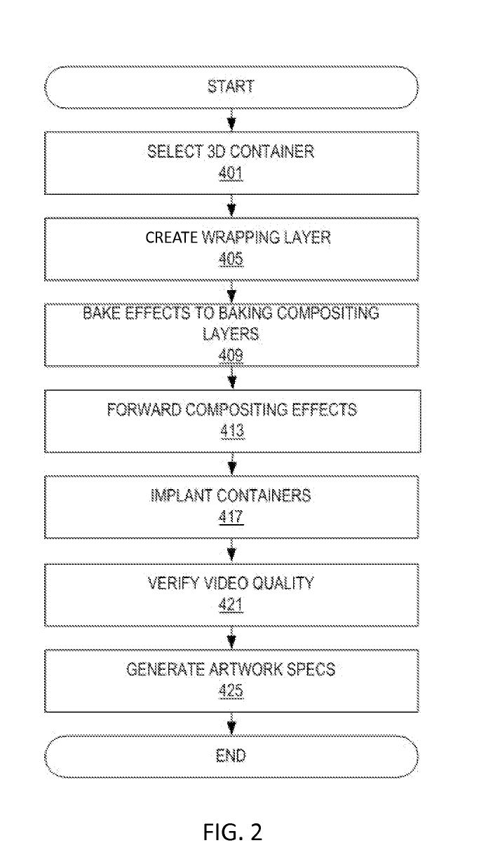

In FIG. 2, a flowchart represents a process performed by another embodiment of the present invention. The process is that of creating a 2D container 344 out of a 3D container 355. The process includes the steps of creating wrapper layer (discussed in more detail with respect to FIG. 9) transforming 3D effects into a set of baking layers, extracting 2D effects, and saving them as part of the 2D container.

The process of FIG. 2 begins by selecting a 3D container. (Step 401.) Then, wrapping layers are extracted. (Step 405.) After that, effects are baked to compositing baking layers. (Step 409.) Then, compositing effects are forwarded. (Step 413.) The next step is to implant the containers. (Step 417.) Then, video quality is verified. (Step 421.) Finally, artwork specs are generated. (Step 425.)

In FIG. 6, a flowchart represents a process performed by an embodiment of the present invention. The process is that of rendering, can be performed for example by the renderer 164 or by the network renderer 64 discussed above. Entire frames are processed one after the other according to their original sequence. For every frame that needs to be processed according to a 2D container 344, all pixels are processed in that frame to create new frame based on a composition comprising a pixel from the original video, a pixel from the artwork, and pixels from the baking layers 364.

The process of FIG. 6 begins by receiving a video stream. (Step 801.) Then, the frame index is detected. (Step 802.) At this point, it is queried whether there are more frames. (Step 802.1.) If there are no more frames, the process ends.

If there are more frames, it is queried whether the frame needs to be processed. (Step 802.2.) If the result is affirmative, the frame is processed. (Step 803.) Then, the next pixel is selected. (Step 804.) If the result of the query of step 802.2 is negative, the process flow proceeds directly to step 804 without executing step 803.

It is then queried whether there are more pixels in the present frame. (Step 804.1.) If there are no more pixels, the process flow returns to step 801. If instead there are more pixels to process, the pixel is processed. (Step 805.) Then, a pixel map is chosen. (Step 806.) After that, artwork for the pixel is chosen. (Step 807.) Then, a pixel in the destination frame is chosen. (Step 808.) After that, pixels are processed for composition. (Step 809.) When this is completed, the process flow returns to step 803.

In FIG. 8, a flowchart represents a process of preparing video content for future embedding of artwork performed by an embodiment of the invention. An operator scans the content to find appropriate scenes for planting a 2D container using a container implanter (such as the container implanter 162 discussed with reference to FIG. 1). When the operator finds such a scene, he generates a 2D container (such as the 2D container 344 discussed with reference to FIG. 4) using the flow described above with reference to FIG. 2. Then, the operator looks for additional scenes for 2D containers. When all desired scenes are processed, the user modifies the original video content by (but not necessarily only by) re-transcoding the video by putting I-FRAME in every frame that is part of a 2D container.

The process of FIG. 8 begins by seeking the next place for a container. (Step 501.) It is then queried whether the present container is the last container to be processed. (Step 501.1.) If it is not the last container, a 2D container is implanted. (Step 501.1.) Then, the process flow returns to step 501.

If the result of the query of step 501.1 is that the present container is the last container, the video is transcoded. (Step 503.) Then, metadata, for example, that shown in FIG. 5 or the 2D container of FIG. 4, is uploaded, for example, to the distributer 122 or to another network file server. (Step 504.) At this point, the process ends.

The invention may also be embodied as a machine readable storage medium containing instructions. As non-limiting examples, the machine readable medium could be embodied as the hard drive of a server hosting a container implanter (such as the container implanter 162 of FIG. 1). Alternatively, the a machine readable medium of the present embodiment may be an external hard drive in operative communication with a server, or the machine readable medium any of various types of non-volatile memory, such as flash memory, read-only memory (ROM), programmable read-only-memory (PROM) or electronically-erasable read-only-memory (E2ROM). Other types of non-transitory storage media are within the scope of the invention. The machine readable medium may also be maintained by an independent party for distribution of the instructions (embodied as software code) to others upon request.

The instructions stored in the storage medium of the present embodiment, when executed, cause a container implanter to provide for real time photo realistic rendering of artwork onto video content by: defining segments in the video content; defining 3D containers for the segments; converting the 3D containers into corresponding 2D containers; and sending the 2D containers through a network. The video content, the artwork, and the 2D containers become available to a viewer activating an electronic device to receive through the network the video content and the artwork and to play the video content with the artwork photo realistically rendered thereon according to instructions in the 2D containers.

Variations of the embodiment are within the scope of the invention. For example, the 2D containers may be sent to a designated server that is distinct from the viewer's electronic device. The video content, the artwork, and the 2D containers may be each provided for rendering from independently operated servers. Also, the viewer's electronic device may be activated (1) to receive also through the network the instructions in the 2D containers and (2) to photo realistically render the artwork onto the video content according to the instructions. Alternatively, the viewer's electronic device is activated to receive a video stream of the video content with the artwork photo realistically rendered thereon according to the instructions in the 2D containers.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A method of providing for real time photo realistic rendering of artwork onto video content, the method comprising:
activating a computer to define segments in the video content;
activating the computer to define 3D containers for the segments;
activating the computer to convert the 3D containers into corresponding 2D containers; and
sending the 2D containers through a network;
wherein the video content, the artwork, and the 2D containers become available to a viewer activating an electronic device to receive through the network the video content and the artwork and to play the video content with the artwork photo realistically rendered thereon according to instructions in the 2D containers.

2. The method of claim 1, wherein the 2D containers are sent to a designated server distinct from the viewer's electronic device.

3. The method of claim 1, wherein the video content, the artwork, and the 2D containers are each provided for rendering from independently operated servers.

4. The method of claim 1, wherein the viewer's electronic device is activated (1) to receive also through the network the instructions in the 2D containers and (2) to photo realistically render the artwork onto the video content according to the instructions.

5. The method of claim 1, wherein the viewer's electronic device is activated to receive a video stream of the video content with the artwork photo realistically rendered thereon according to the instructions in the 2D containers.

6. A container implanter residing on a computer, the container implanter comprising:
a 3D to 2D converter residing on the computer and operative to convert 3D containers for segments defined in video content into 2D containers; and
network access circuitry enabling the receipt of the video content through a network and the transmission of the 2D containers through the network;
wherein, when activated, the 3D to 2D converter converts the 3D containers for the segments defined in the video content into 2D containers and the 2D containers are sent through the network using the network access circuitry so that the video content, the artwork, and the 2D containers become available to a viewer activating an electronic device to play the video content with the artwork photo realistically rendered thereon according to instructions in the 2D containers.

7. The container implanter of claim 6, wherein the 2D containers are sent to a designated distinct from the viewer's electronic device.

8. The container implanter of claim 6, wherein the video content, the artwork, and the 2D containers are each provided for rendering from independently operated servers.

9. The container implanter of claim 6, wherein the viewer's electronic device is activated (1) to receive also through the network the instructions in the 2D containers and (2) to photo realistically render the artwork onto the video content according to the instructions.

10. The container implanter of claim 6, wherein the viewer's electronic device is activated to receive a video stream of the video content with the artwork photo realistically rendered thereon according to the instructions in the 2D containers.

11. A machine readable storage medium containing instructions that when executed cause a container implanter to provide for real time photo realistic rendering of artwork onto video content by:
defining segments in the video content;
defining 3D containers for the segments;
converting the 3D containers into corresponding 2D containers; and
sending the 2D containers through a network;
wherein the video content, the artwork, and the 2D containers become available to a viewer activating an electronic device to receive through the network the video content and the artwork and to play the video content with the artwork photo realistically rendered thereon according to instructions in the 2D containers.

12. The machine readable storage medium of claim 11, wherein the 2D containers are sent to a designated server distinct from the viewer's electronic device.

13. The machine readable storage medium of claim 11, wherein the video content, the artwork, and the 2D containers are each provided for rendering from independently operated servers.

14. The machine readable storage medium of claim 11, wherein the viewer's electronic device is activated (1) to receive also through the network the instructions in the 2D containers and (2) to photo realistically render the artwork onto the video content according to the instructions.

15. The machine readable storage medium of claim 11, wherein the viewer's electronic device is activated to receive a video stream of the video content with the artwork photo realistically rendered thereon according to the instructions in the 2D containers.
